(19) United States
(12) Patent Application Publication
(10) Pub. No.: US 2006/0126716 A1
(43) Pub. Date: Jun. 15, 2006

(54) Digital remodulation

(75) Inventors: Wendi Williams, Lake Worth, FL (US); Paul Marko, Pembroke Pines, FL (US); Craig Wadin, Sunrise, FL (US)

Correspondence Address: AKERMAN SENTERFITT, P.O. BOX 3188, WEST PALM BEACH, FL, 33402-3188, US

(73) Assignee: XM Satellite Radio, Inc., Washington, DC (US)

(21) Appl. No.: 11/012,579

(22) Filed: Dec. 15, 2004

(51) Int. Cl. H04B 1/66; H04B 14/04

(52) U.S. Cl. 375/240; 375/242

(57) ABSTRACT

A method (30) of digital remodulation of a received or source signal using a digital audio radio (116) having a first digital radio frequency path (119 to 116) or using a first digital radio frequency comprises the steps of re-encoding (38) the received signal to provide a re-encoded digital signal, reformatting (40) the re-encoded digital signal into a new digital format signal, and digitally modulating (42) a radio frequency carrier with the new digital format signal. The method further comprises the step of selectively switching (42) a radio frequency path of the digital audio radio from the first digital radio frequency path to a second radio frequency path (114 to 116) or from the first digital radio frequency to a second digital radio frequency having the radio frequency carrier with the new digital format signal.

### CROSS-REFERENCE TO RELATED APPLICATIONS

(not applicable)

### FIELD OF THE INVENTION

The invention relates generally to modulation techniques, and more particularly to digital remodulation of a source signal.

### BACKGROUND OF THE INVENTION

Satellite radio improves over terrestrial radio's potential by offering a better audio quality in a digital format, greater coverage and fewer commercials. Accordingly, in October of 1997, the Federal Communications Commission (FCC) granted two national satellite radio broadcast licenses one of which are owned by the assignee of the present application “XM Satellite Radio Inc.” The system plan for XM Satellite Radio includes digital transmission of substantially the same program content from two or more geosynchronous or geostationary satellites to both mobile and fixed receivers on the ground. In urban canyons and other high population density areas with limited line-of-sight (LOS) satellite coverage, terrestrial repeaters rebroadcast the same program content in order to improve coverage reliability. The high quality digital signal broadcast by XM Satellite Radio is ideally received by a digital satellite receiver for best audio reproduction, but in many instances an analog frequency modulation technique is utilized to reproduce the digital signal to take advantage of existing FM receiver car audio hardware. An example of such technique is described in U.S. Pat. No. 6,272,328 assigned to the assignee herein by Nguyen et al. and hereby incorporated by reference ('328 patent). Unfortunately, in any digital to analog conversion, the quality of the output signal may be degraded.

Digital Audio Broadcasting is a medium for providing digital-quality audio, superior to existing analog broadcasting formats. FM (in-band over carrier) IBOC DAB can be transmitted in a hybrid format where the digitally modulated signal coexists with the currently broadcast analog FM signal. IBOC requires no new spectral allocations because each DAB signal is simultaneously transmitted within the spectral mask of an existing FM channel allocation. IBOC promotes economy of spectrum while enabling broadcasters to supply digital quality audio to their present base of listeners. FM IBOC broadcasting systems have been the subject of several United States patents. The advantages of digital transmission for audio include better signal quality with less noise and wider dynamic range than with existing FM radio channels. Initially the hybrid format would be adopted allowing the existing receivers to continue to receive the analog FM signal while allowing new IBOC receivers to decode the digital signal. Some time in the future, when IBOC DAB receivers are abundant, broadcasters may elect to transmit an all-digital format. The goal of FM hybrid IBOC DAB is to provide virtual-CD-quality stereo digital audio (plus data) while simultaneously transmitting the existing FM signal. The goal of FM all-digital IBOC DAB is to provide virtual-CD-quality stereo audio along with a data channel with capacity of up to about 200 kbps, depending upon a particular station's interference environment.

With the emergence of FM digital IBOC DAB, radios made to receive and reproduce such digital signals will be able to provide additional advantages not yet contemplated in the reproduction of quality audio (and other data) from sources other than the FM digital IBOC DAB signal. Thus existing systems fail to contemplate taking full advantage of the digital quality of digital radio in reproducing quality digital output from auxiliary sources.

### SUMMARY

In a first aspect of the present invention, a method of digital remodulation of a received (or source) signal using a digital audio radio using a first digital radio frequency or having a first digital radio frequency path comprises the steps of re-encoding the received signal to provide a re-encoded digital signal, reformatting the re-encoded digital signal into a new digital format signal, and digitally modulating a radio frequency carrier with the new digital format signal. The method further comprises the step of selectively switching the digital audio radio from the first digital radio frequency to a second radio frequency having the radio frequency carrier with the new digital format signal. The step of selectively switching can optionally involve switching a radio frequency path of the digital audio radio from a first digital radio frequency path to a second radio frequency path having the radio frequency carrier with the new digital format signal.

In a second aspect of the present invention, a method of providing an audio signal from an auxiliary source to a digital radio receiver for playback in lieu of a digital broadcast signal received at the digital radio receiver comprises the steps of reformatting the audio signal into a digital audio format compatible with the digital broadcast signal, modulating the reformatted audio signal onto a radio frequency to which the radio receiver can be tuned for transmission via a conductor. The method can further include the step of providing the modulated reformatted audio signal to an antenna switch unit via the conductor, the antenna switch unit also being connected to an antenna for receiving the broadcast signal.

In a third aspect of the present invention, an apparatus for providing audio signals from an auxiliary source to a digital audio radio receiver that receives a digital broadcast signal via an antenna comprises an encoder for encoding the audio signals from the auxiliary source to provide a re-encoded signal, a formatter for formatting the re-encoded signal into a digital audio format compatible with the digital broadcast signal providing a reformatted digital audio signal, and a modulator unit for modulating the reformatted digital audio signal onto a radio frequency to which said digital audio radio receiver can be tuned. The apparatus can further optionally include an antenna switch unit having an output connected to the digital audio radio receiver, a first input connected to the antenna and a second input. The apparatus can also include a conductor connected at one end thereof to an output of the modulator unit and connected at the other end thereof to the second input, the antenna switch unit including a switching device for selectively switching between the first input and the second input for providing the corresponding one of the digital broadcast signal and the modulated reformatted digital audio signal to the output.

### BRIEF DESCRIPTION OF THE DRAWINGS

FIG. 1 is a block diagram of a conventional FM modulated system that modulates satellite signals via an existing analog FM radio receiver system.

FIG. 2 is a simple block diagram illustrating an auxiliary source that is converted for use in a digital radio in accordance with an embodiment of the present invention.

FIG. 3 is a flow diagram illustrating a method of digital remodulation of a received signal using a digital audio radio in accordance with an embodiment of the present invention.

FIG. 4 is a block diagram of a digital FM modulated system that modulates satellite signals (or other alternative sources) via an digital FM radio receiver system in accordance with and embodiment of the present invention.

FIG. 5 is a block diagram of another digital FM modulated system that modulates a source signal via an digital FM radio receiver system in accordance with an embodiment of the present invention.

### DETAILED DESCRIPTION OF THE DRAWINGS

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

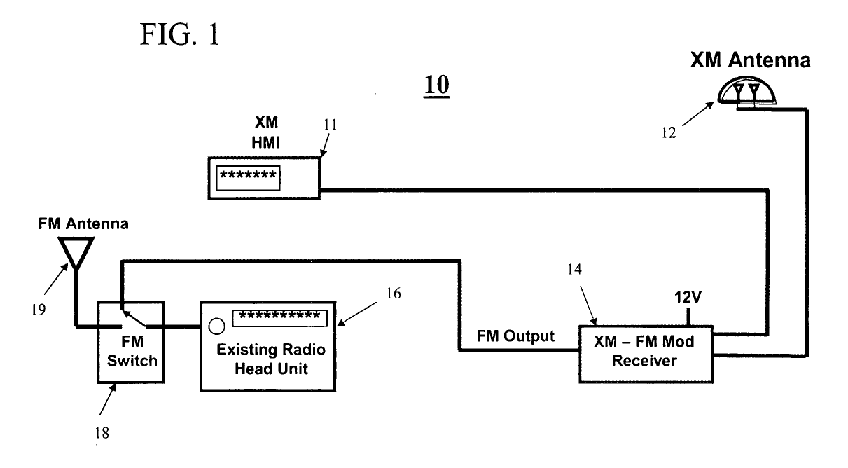

With reference to FIG. 1, a system 10 for transmitting audio signals from an auxiliary source (an XM Satellite radio receiver 11 in conjunction with a combined satellite and terrestrial antenna 12 in the case of an XM Satellite Radio system) to a radio receiver or an existing radio head unit (e.g., an AM/FM tuner) 16. The radio receiver 16 is preferably the existing tuner in a vehicle. The tuner is connected to an antenna 19 for receiving, for example, AM and/or FM radio broadcasts. The vehicle also comprises a battery for powering the radio receiver 16 and a modulator unit 14. The 12 volts that is typically supplied by a conventional car battery can be reduced to a lower voltage via a voltage divider circuit for example. With continued to reference FIG. 1, the system 10 comprises the modulator unit 14 and an antenna switch unit 18. The system 10 allows an audio signal from an auxiliary audio source (11 and 12) to be modulated into the operational RF band of the tuner 16 for transmission thereto. The tuner 16 is preferably a conventional amplitude modulation/frequency modulation (AM/FM) radio receiver. It is to be understood that the tuner 16 and the system 10 can be configured to operate at radio frequencies other than the AM and FM radio broadcast bands.

The auxiliary source (11 and 12) can be an Sband satellite broadcast receiver, for example, for receiving a satellite digital audio radio service (SDARS), a CD player, or a tape cassette player, among other sources. The satellite broadcast receiver can also be operated in other RF bands and can have, for example, an L-band or UHF front end for use with direct audio broadcast (DAB) systems in different countries. The satellite broadcast receiver downconverts a received broadcast signal to a baseband signal or to an intermediate frequency (IF) signal.

The audio signal from the auxiliary source (11 and 12) is provided to the modulator unit 14. The modulator unit 14 has an audio input for the input audio signal from the auxiliary source 11 and an output line coupled to the antenna switch unit 18 which selectively provides the tuner 16 with an input from either the FM antenna 19 or the signal from the auxiliary source modulated on an FM carrier. The RF modulator frequency can modulate a composite stereo signal to a frequency within the operating RF band of the tuner (i.e., from 87.7 megahertz (MHz) to 108 MHz). As described in the '328 patent, the antenna switch unit described therein can detect the presence of the output of the modulator unit and operates a switching device to provide the signal from the modulator unit to the tuner in lieu of a radio broadcast received by the FM antenna. Thus, no interference occurs as between the antenna 19 and the modulator unit 14. The FM modulator 14 is preferably operable to modulate the audio signal from the auxiliary source 11 to a selected channel such as 88.5 MHz, for example. Thus, a user can set a programmable channel selection button on the tuner 16 for tuning to 88.5 MHz to listen to a satellite broadcast. In addition, the FM modulator 14 can be operable to modulate the audio signal from the auxiliary source to one of a plurality of selected RF channels. Accordingly, one of these channels is selected when the system 10 is installed in a vehicle. The selected channel can be selected to have the lowest noise level in the geographic area where the vehicle is most frequently driven. A programmable channel selection button on the tuner 16 can then be set to the selected channel.

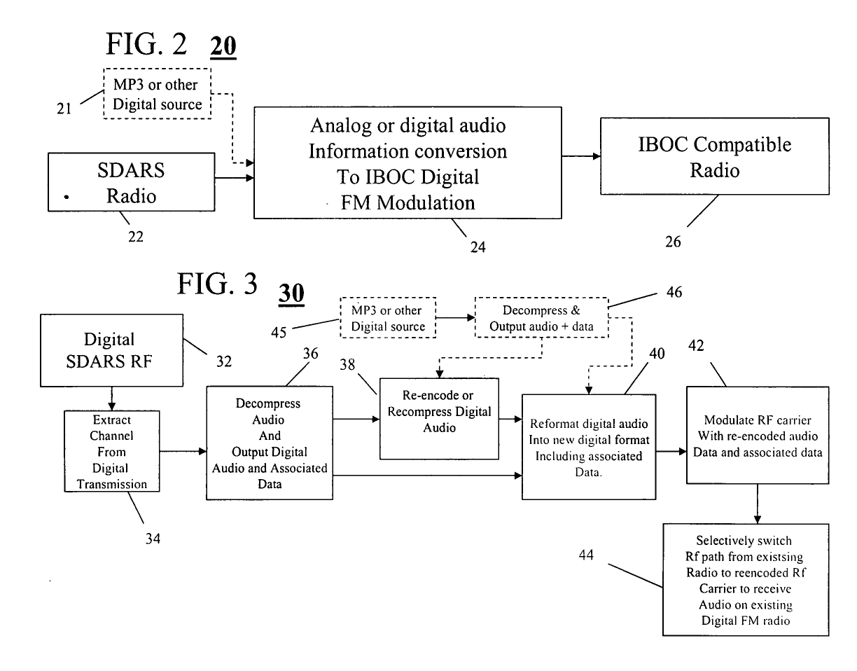

Referring to FIG. 2, a simplified block diagram is shown illustrating at least one auxiliary source that is converted from one digital format to another digital format using a digital radio in accordance with the present invention. In a particular embodiment of a system 20 in accordance with the present invention, a satellite digital audio radio system radio 22 serves as the auxiliary source and provides a digital signal that is modulated at module 24 for use with a IBOC digital radio 26. In an alternative embodiment, the module 24 can modulate a signal from another auxiliary source 21 as a digital MP3 player.

Referring to FIG. 3 a more detailed flow diagram 30 illustrating a method of digital remodulation of a source signal such as a received digital satellite signal (or other alternative source) using a digital audio radio in accordance with the present invention is shown. First, a radio frequency signal from a satellite digital audio radio system is received at step 32 whereupon a channel can be extracted from the digital transmission at step 34. The channel may contain audio and associated data and preferably the audio and/or associated data is compressed. At step 36 the audio and/or associated data are decompressed. Alternatively or optionally, another source 45 such as an MP3 player can provide an audio signal and/or associated data which can also be decompressed at step 46. In either case, the digital audio can be re-compressed or re-encoded at step 38. Once re-encoded or re-compressed, the digital audio can be reformatted at step 40. The associated data is also reformatted at step 40. Note that the associated data does not necessarily need to be re-encoded or re-compressed before digital reformatting. The re-encoding and re-formatting should place the audio data in a format compatible with an existing digital radio. To utilize the present invention, an RF carrier should be modulated with the re-encoded (and re-formatted) audio data and associated data at step 42 whereupon the RF path on a digital radio system is switched (44) from an existing radio to the re-encoded RF carrier to receive audio on the existing digital radio. Further note, the associated data in the case of a system using a satellite radio as a source signal can include channel name, artist name, and song title for example. In the case of an a satellite radio or MP3 player, the associated data can also include album name, song length, copyright date, and other miscellaneous data if desired. All or a portion of this associated data can be remodulated or passed-though to the RF modulator.

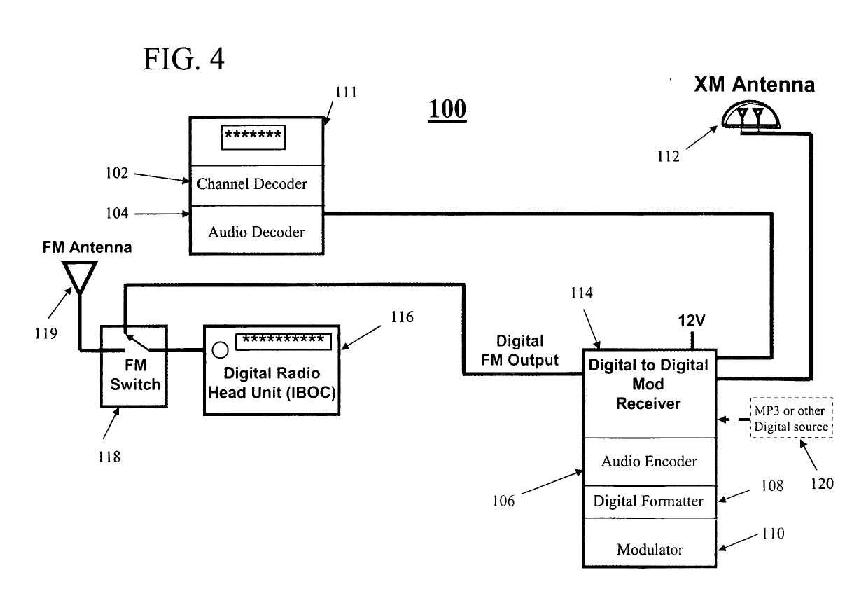

Referring to FIG. 4, a system 100 for transmitting audio signals from an auxiliary source (such as an XM Satellite radio receiver 111 in conjunction with a combined satellite and terrestrial antenna 112 in the case of an XM Satellite Radio system or from another alternative auxiliary source 120 such as an MP3 player) to a digital radio receiver or an existing digital radio head unit (e.g., an AM/FM tuner) 116. The digital radio receiver 116 is preferably a digital IBOC tuner that will soon be found in vehicles. The tuner 116 is connected to an antenna 119 for receiving, for example, digital AM and/or digital FM radio broadcasts. The tuner may also be capable of receiving traditional analog and AM and FM radio broadcasts. The vehicle also comprises a battery for powering the radio receiver 116 and a modulator unit 114. As previously noted, the 12 volts that is typically supplied by a conventional car battery can be reduced to a lower voltage via a voltage divider circuit for example. With continued reference FIG. 4, the system 100 can include the modulator unit 114 and an antenna switch unit 118. The system 100 allows an audio signal from an auxiliary audio source (111 and 112 or alternatively source 120) to be modulated into the operational RF band of the digital tuner 116 for transmission thereto. The digital tuner 116 can be a digital amplitude modulation/frequency modulation (AM/FM) radio receiver. It is to be understood that the digital tuner 116 and the system 100 can be configured to operate at radio frequencies other than the AM and FM radio broadcast bands.

The auxiliary source (111 and 112) can be an Sband satellite broadcast receiver, for example, for receiving a satellite digital audio radio service (SDARS), or the alternative auxiliary source 120 can be an MP3 player, a CD player, or a tape cassette player, among other sources. The satellite broadcast receiver can also be operated in other RF bands and can have, for example, an L-band or UHF front end for use with direct audio broadcast (DAB) systems in different countries. The satellite broadcast receiver preferably downconverts a received broadcast signal to a baseband signal or to an intermediate frequency (IF) signal.

The audio signal from the auxiliary source (111 and 112) or from auxiliary source 120 is provided to the modulator unit 114. The modulator unit 114 has an audio input for the input audio signal from the auxiliary source 111 (or 120) and an output line coupled to the antenna switch unit 118 which selectively provides the digital tuner 116 with an input from either the FM antenna 119 or the signal from the auxiliary source modulated on an FM carrier. The RF modulator frequency can preferably modulate a composite stereo signal to a frequency within the operating RF band of the tuner (i.e., from 87.7 megahertz (MHz) to 108 MHz). The antenna switch unit 118 can preferably detect the presence of the output of the modulator unit 114 and operates the switching device 118 to provide the signal from the modulator unit to the digital tuner 116 in lieu of a radio broadcast received by the FM antenna. Thus, no interference occurs as between the antenna 119 and the modulator unit 114. The FM modulator 114 is preferably operable to modulate the audio signal from the auxiliary source 111 to a selected channel such as 88.5 MHz, for example. Thus, a user can set a programmable channel selection button on the digital tuner 116 for tuning to 88.5 MHz to listen to a satellite broadcast. In addition, the FM modulator 114 can be operable to modulate the audio signal from the auxiliary source to one of a plurality of selected RF channels. Accordingly, one of these channels is selected when the system 10 is installed in a vehicle. The selected channel can be selected to have the lowest noise level in the geographic area where the vehicle is most frequently driven. A programmable channel selection button on the digital tuner 116 can then be set to the selected channel.

The auxiliary source 111 is preferably a satellite digital audio radio system including a channel decoder 102 that decodes a selected channel from a digital data stream and a audio decoder 104 that decodes or decompresses audio and outputs digital audio and associated data. The FM modulator unit 114 then also preferably serves to re-compress or re-encode the decompressed audio using a digital audio encoder 106. The FM modulator may also re-format the re-encoded digital data into a format compatible with the digital FM radio 116 using a digital reformatter 108. Of course, the modulator unit 114 preferably includes a modulator 110 enabling an RF carrier to be modulated with the re-encoded (and re-formatted) audio data and associated data. Thus, during operation the switch 118 switches the RF path on a digital radio system from the FM antenna 119 and digital radio 116 to the re-encoded RF carrier to receive audio on the existing digital radio 116.

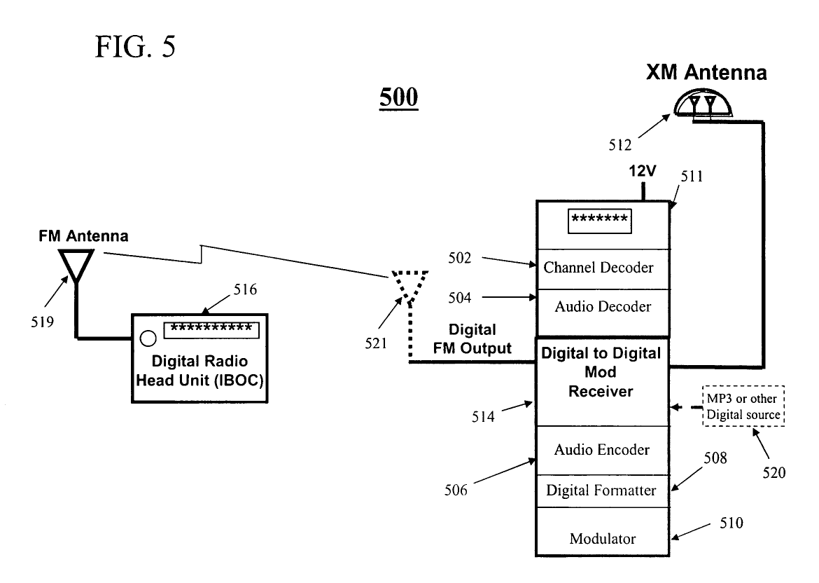

Referring to FIG. Referring to FIG. 5, an alternative system 500 similar to system 100 of FIG. 4 can transmit audio signals from an auxiliary source (such as an XM Satellite radio receiver unit 511 in conjunction with a combined satellite and terrestrial antenna 512 in the case of an XM Satellite Radio system or from another alternative auxiliary source 520 such as an MP3 player) to a digital radio receiver or an existing digital radio head unit (e.g., an AM/FM tuner) 516. In this embodiment, the satellite radio receiver unit 511 includes a channel decoder 502 that decodes a selected channel from a digital data stream and a audio decoder 504 that decodes or decompresses audio and outputs digital audio and associated data. The unit 511 can further include an integrated modulator unit 514 having an audio encoder 506, a digital formatter 508, and modulator 510 similar to the encoder, formatter, and modulator of modulator unit 114 of FIG. 4. The FM modulator unit 514 then also preferably serves to re-compress or re-encode the decompressed audio using the digital audio encoder 506. The FM modulator may also re-format the re-encoded digital data into a format compatible with the digital FM radio 516 using the digital formatter 508. Of course, the modulator unit 514 preferably includes the modulator 510 enabling an RF carrier to be modulated with the re-encoded (and re-formatted) audio data and associated data.

The tuner 516 is connected to an antenna 519 for receiving, for example, digital AM and/or digital FM radio broadcasts. The tuner may also be capable of receiving traditional analog and AM and FM radio broadcasts. The modulated signal from the modulator unit 514 can be radiated out in several ways for reception by the antenna 519. In one instance, the satellite receiver unit 511 (and integrated modulator unit 514) can include an internal radiator (not shown). In another alternative, the modulated signal from the modulator unit 514 can be radiated via an antenna 521 for reception by the tuner 516 via antenna 519. In yet another alternative, the modulated signal from the modulator unit 514 can be radiated via an antenna 512 for reception by the tuner 516 via antenna 519. The antenna 512 can be an antenna unit that serves the dual purpose of receiving satellite signals, but also radiates FM modulated signals as is more fully described in U.S. patent application No. XX/XXXXXX (Attorney Docket No. 7042-22) by the assignee herein and hereby incorporated by reference.

The system 500 can be in a vehicle that also comprises a battery for powering the radio receiver 516 and the receiver unit 511 as well as the modulator unit 514. The 12 volts that is typically supplied by a conventional car battery can be reduced to a lower voltage via a voltage divider circuit for example. With continued reference FIG. 4, the system 500 can radiate a modulated FM signal and thereby avoid the use of an antenna switch unit as found in the system 100 of FIG. 4.

The audio signal from the auxiliary source (511) or from auxiliary source 520 is provided to the modulator unit 514. The modulator unit 514 can have an audio input for the input audio signal from the auxiliary source 511 (or 520) and an output line coupled to a radiator such as antenna 521. The RF modulator frequency can preferably modulate a composite stereo signal to a frequency within the operating RF band of the tuner (i.e., from 87.7 megahertz (MHz) to 108 MHz). The FM modulator 514 is preferably operable to modulate the audio signal from the auxiliary source 511 or 520 to a selected channel such as 88.5 MHz, for example. Thus, a user can set a programmable channel selection button on the digital tuner 516 for tuning to 88.5 MHz to listen to a satellite broadcast or from another auxiliary source such as an MP3 player. In addition, the FM modulator 514 can be operable to modulate the audio signal from the auxiliary source to one of a plurality of selected RF channels. Accordingly, one of these channels is selected when the system 10 is installed in a vehicle. The selected channel can be selected to have the lowest noise level in the geographic area where the vehicle is most frequently driven. A programmable channel selection button on the digital tuner 516 can then be set to the selected channel.

Further, the present invention is not limited to use in satellite radio applications. As previously noted, the concepts of present invention could be used with other auxiliary sources such as CD, DVD, MP3, and tape players. Indeed the teachings of the present invention may be utilized for various applications at various frequencies or with different modulation schemes without departing from the scope thereof.

It is therefore intended by the appended claims to cover any and all such applications, modifications and embodiments within the scope of the present invention. The description above is intended by way of example only and is not intended to limit the present invention in any way except as set forth in the following claims.

We claim:

1. A method of digital remodulation of a received signal using a digital audio radio and a first digital radio frequency, comprising the steps of:
re-encoding the received signal to provide a re-encoded digital signal;
reformatting the re-encoded digital signal into a new digital format signal;
digitally modulating a radio frequency carrier with the new digital format signal; and
selectively switching the digital audio radio from the first digital radio frequency to a second radio frequency having the radio frequency carrier with the new digital formal signal.

2. The method of claim 1, wherein the method further comprises the step of receiving the new digital format signal at the digital audio radio.

3. The method of claim 1, wherein the method further comprises the step of receiving the received signal in a, format of a digital transmission signal, extracting a channel of encoded information, and decoding a the channel of encoded information before the step of re-encoding.

4. The method of claim 1, wherein the method further comprises the step of receiving the received signal in a format of a satellite digital audio radio transmission signal, extracting a channel of encoded audio, and decoding the channel of encoded audio before the step of re-encoding.

5. The method of claim 1, wherein the method further comprises the step of receiving the received signal in a format of a satellite digital audio radio transmission signal, extracting a compressed channel of encoded audio, and decompressing the compressed channel of encoded audio before the step of re-encoding.

6. The method of claim 1, wherein the method further comprises the step of receiving the received signal in a format of a satellite digital audio radio transmission signal, extracting a channel having a compressed digital audio signal and associated data from the satellite digital audio radio transmission signal, and decompressing the compressed digital audio signal and associated data.

7. The method of claim 6, wherein the step of re-encoding comprises the step of re-encoding only the decompressed digital audio radio signal to provide the re-encoded digital audio signal and the step of reformatting comprises the step of reformatting the re-encoded digital audio radio signal and the associated data.

8. The method of claim 3, wherein the step of receiving the received signal comprises the step of receiving a digital stream generated from an auxiliary audio source selected from the group comprising an MP3 player, a compact disc player, a digital video disc player, a tape cassette player, and a satellite digital audio radio receiver.

9. A method of providing an audio signal from an auxiliary source to a digital radio receiver for playback in lieu of a digital broadcast signal received at the digital radio receiver comprising the steps of:
reformatting the audio signal into a digital audio format compatible with the digital broadcast signal;
modulating the reformatted audio signal onto a radio frequency to which the radio receiver can be tuned, for transmission via a conductor; and
providing the modulated reformatted audio signal to an antenna switch unit via the conductor, the antenna switch unit also being connected to an antenna for receiving the broadcast signal.

10. The method of claim 9, wherein the method further comprises the steps of detecting when said reformatted modulated audio signal is being provided to said antenna switch unit and operating a switch to provide said reformatted modulated audio signal to said radio receiver in response to said reformatted modulated audio signal being detected at said antenna switch unit and to provide said broadcast signal to said radio receiver when said reformatted modulated audio signal is not detected.

11. A method as claimed in claim 10, wherein said detecting step comprises the step of detecting when said reformatted modulated audio signal provided to said antenna switch unit exceeds a predetermined voltage level, and said operating step comprises the step of providing said radio receiver said broadcast signal when said reformatted modulated audio signal is below said predetermined voltage level.

12. An apparatus for providing audio signals from an auxiliary source to a digital audio radio receiver, said digital audio radio receiver receiving a digital broadcast signal via an antenna, the apparatus comprising:
an encoder for encoding the audio signals from the auxiliary source to provide a re-encoded signal;
a formatter for formatting the re-encoded signal into a digital audio format compatible with the digital broadcast signal providing a reformatted digital audio signal; and
a modulator unit for modulating the reformatted digital audio signal onto a radio frequency to which said digital audio radio receiver can be tuned.

13. The apparatus of claim 12, wherein the apparatus further comprises:
an antenna switch unit having an output connected to said digital audio radio receiver, a first input connected to said antenna and a second input; and
a conductor connected at one end thereof to an output of said modulator unit and connected at the other end thereof to said second input, said antenna switch unit comprising a switching device for selectively switching between said first input and said second input for providing the corresponding one of said digital broadcast signal and said modulated reformatted digital audio signal to said output.

14. The apparatus of claim 13, further comprising a radio frequency detection and switching control device for controlling said switch device to automatically provide said modulated reformatted digital audio signal to said output in response to said modulated reformatted digital audio signal being provided to said antenna switch unit.

15. The apparatus of claim 12, wherein the auxiliary source is selected from the group comprising an MP3 player, a compact disc player, a digital video disc player, a tape cassette player, and a satellite digital audio radio receiver.

16. The apparatus of claim 12, wherein the auxiliary source is an satellite digital audio radio receiver and the digital audio radio receiver is an in-band on carrier terrestrial digital receiver.

17. The apparatus of claim 16, wherein the modulator unit is coupled to a satellite digital radio receiver antenna for receiving the auxiliary source over the air.

18. The apparatus of claim 12, wherein the apparatus further comprises a channel decoder for extracting a channel of digital information from the auxiliary source.

19. The apparatus of claim 18, wherein the digital information comprises digital audio and associated digital information and wherein the apparatus further comprises a decompressor for decompressing the digital information.

20. The apparatus of claim 19, wherein the encoder re-encodes the digital audio and the formatter re-formats the associated digital information and the re-encoded digital audio and the modulator unit modulates the re-encoded digital audio and the associated digital information.
